(19) United States
(12) Patent Application Publication
(10) Pub. No.: US 2008/0320090 A1
(43) Pub. Date: Dec. 25, 2008

(54) SYSTEM AND METHOD FOR REVIEW OF DISCUSSION CONTENT

(76) Inventor: Callan H. Bryan, Davidson, NC (US)

Correspondence Address: MCNAIR LAW FIRM, P.A., P.O. BOX 10827, GREENVILLE, SC, 29603-0827, US

(21) Appl. No.: 12/017,832

(22) Filed: Jan. 22, 2008

Related U.S. Application Data
(60) Provisional application No. 60/881,254, filed on Jan. 19, 2007.

(51) Int. Cl. G06F 15/16; G06F 7/08; G06F 17/30

(52) U.S. Cl. 709/206; 707/7; 707/E17.009

(57) ABSTRACT

This invention is a content review system having a computer readable medium which can contain member information embodied in the computer readable medium representing individuals that wish to participate in online discussions where each member has an electronic address. Computer readable instructions provide for receiving initial discussion content generated by an originating member, generating a new discussion notification, transmitting the new discussion notification to the members, receiving a comment to the initial discussion content from a commenting member, transmitting the comment to each member, receiving review information from a reviewing member wherein the review is associated with the comment and wherein the review information include feedback information selected from the group of concur, concur and comment, neutral comment, dissent and dissent and comment, and transmitting the review information to at least one member.

### FIELD OF THE INVENTION

This invention is directed to a system and method for evaluating responses to distributed queries and more specifically, to a system and method allowing responses to distributed queries to be reviewed by third parties thereby providing peer review of responses to distributed inquiries.

### BACKGROUND OF THE INVENTION

With modern communications available for mass distribution of information and communications, are many systems that allow individuals that have inquiries to post these queries to either target groups or to the general public. Technologies such as e-mail, mailing lists, list-servs, newsgroups, web forums, blogs, online discussion groups, message forums, and bulletin boards allow information to be posted and distributed to a vast number of individuals and further provide for an individual with a query to present this query to these vast numbers of individuals.

For example, an Internet forum is technology based on the Internet that allows individuals to hold discussions and post content. The content can be in the form of a query, a response or comment to either. These Internet forums originate in the advent of the Internet which was used by the academic community to post queries, receive responses and otherwise share information. Internet newsgroups also provided this functionality and were readily found as early as the 1980s. Today, there are thousands if not millions of forums on a vast number of topics. Forums can be used by any number of professionals which can include the legal, medical, accounting, research, academic, government, corporate, military, or any number of other communities which have a need for the exchange of information.

Internet forums are also referred to as web forums, message boards, discussion boards, discussion groups, discussion forums, bulletin boards or simply forums. A forum is essentially a website composed of a number of member-written provided threads. A thread is a discussion or conversation in the form comprised of a series of member-written posts. For example, the initial thread may begin with the inquiry, “What is the best method of treating Rheumatoid. Arthritis?” Once the inquiry is posted, there may be any number of responses to this query and even responses and comments to the responses themselves. This initial inquiry and the subsequent responses and comments comprise the thread.

Forums can allow members to post anonymously or can associate the posting with the member's indentification information. Members can register with a forum using a username and a password and can be granted varying levels of rights. For example, one user can be allowed to post inquiries and responses while another user may only be allowed to review threads. Anonymous posting can be accomplished by allowing posting without associating the posting with the member's indentification information.

Threads in a forum are generally organized where the postings are displayed in chronological order. However, threads can also be displayed in association with the posting itself.

Some forums feature a point system that allows members to add to the points of another member by providing positive feedback for that member or “propping” that member. Further, negative feedback can also be provided thereby reducing he number of “points” awarded to that member. For example, eBay allows members to leave positive, neutral or negative feedback for its members thereby creating a “feedback forum.” In eBay's system, feedback ratings are used to determine each member's feedback score. A positive rating adds 1 to the score, a negative rating decreases it by 1, and a neutral rating has no impact. The higher the feedback score, the more positive ratings the member has received from other members.

Forums can also serve an important role in the exchange of information directed to specific industries or professional areas. Individuals and our society are best served by professionals who have access to the “better” information, data or opinions. For example, in the medical industry, patients will be better assisted, diagnosed and advised if the health care provider has access to better information. The use of a forum can provide better access to information by allowing peers in the medical field, for example, to post queries and responses and to-allow members of the forums to view the query and responses.

However, currently there is no system to allow the responses to an inquiry to be subject to peer review. Further, there is no system that ranks the responses according to peer review.

Individuals also use e-mail based “list-serv” that reaches all of the subscribing members individual e-mail addresses. The subscribing members then cull through all of the e-mails for questions or opinions that may interest them. There may be many responses to a single query, but the e-mails do not appear in order of the query posed. The responses also are not in any particular order and the advice and opinions expressed vary quite widely from very good to very bad advice.

Further, there is no system which assists the reviewer of the inquiry and responses to determine which of the responses are “more correct” than the others. Current forums simply list the response in chronological order or in association with the query or the previous post.

Therefore, there is a need to provide for peer review of responses to inquiries. Further, there is a need to provide the reviewer of the query and response with a way to determine the results of the peer review.

### DESCRIPTION OF THE DRAWINGS

The invention will be more readily understood from a reading of the following specification and by reference to the accompanying drawings forming a part thereof, wherein an example of the invention is shown and wherein:

FIG. 1 is a schematic showing the invention;

FIG. 2 is a schematic of the data flow of the invention;

FIG. 3 is an illustration of the invention in operation;

FIG. 4 is a flow chart of the invention; and,

FIG. 5 is a flow chart of the invention.

### DESCRIPTION OF THE INVENTION

An object or module is a section of computer readable code embodied in a computer. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art. The present invention is a process where members can review electronically posted communications. These reviewers provide feedback associated to the response to a query which is then used to score the response for subsequent reviewers. The reviewers also have the opportunity to add comments to clarify the review indicating why they agree or disagree, what additional information they may need to respond, or with authority to support the position taken by the responder.

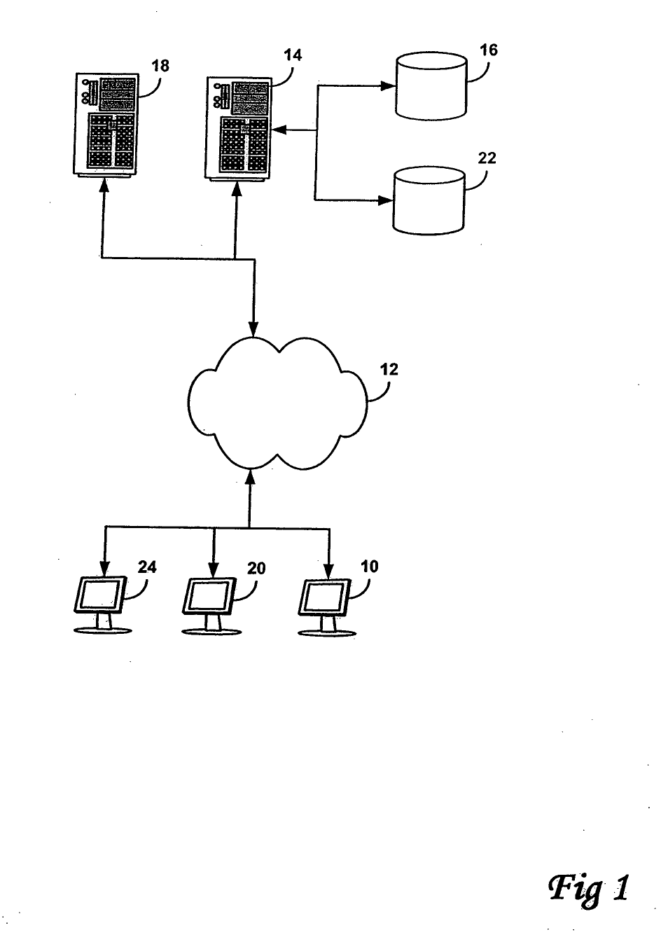

Referring now to FIG. 1, subscriber has a computer terminal 10 and enters a question, statement, opinion, etc. (herein “query”) for which the subscriber wants a response from the members. The query is transmitted through computer network 12 through a data server 14 and the query can be stored in a database 16 communication with server 14. The query has an associated section or topic and is transmitted through e-mail server 18 through network 12 to subscriber 20 who is a subscriber of, opted into, or created either the section or the topic. On one embodiment, an expiration time can be associated with the inquiry so that responses can only be posted for a predetermined period of time. This allows a predetermined

Subscriber, using terminal 20, can submit a response to the query which is transmitted through network 12 to server 14 and can be stored in a database 22 in communication with the server. Once responses are stored in database 22, a response reviewer using terminal 24 can review the responses and provide comments concerning the responses to the query. The review information is stored and associated with the response and can be stored in database 22.

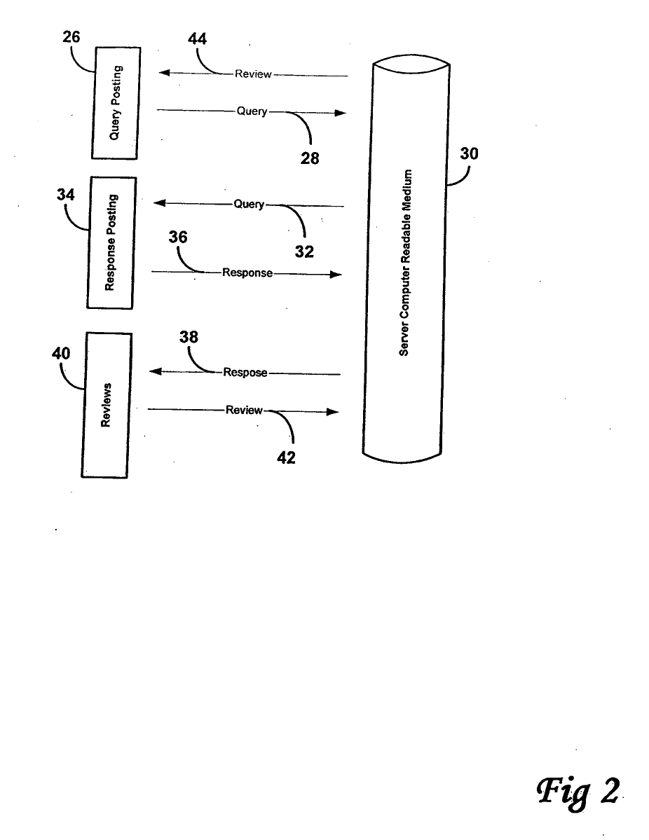

Referring now to FIG. 2, a query is posted originating at location 26 or by otherwise accessing computer readable medium 30 and posting the query to the computer readable medium. Query 28 is transmitted to the server's computer readable medium 30. Computer readable instructions by way of the computer readable medium transmit the query 32 by way of electronic message to subscribers in location 34. The e-mail either contains a link which allows the subscribers to respond with answers to the query by accessing server's computer readable medium 30 or by e-mail. Responses 36 are then transmitted to the computer readable medium through either an e-mail message or through a website to be stored in computer readable medium 30. Responses 36, or notification of the responses are then transmitted to subscribers or can be accessed by anyone browsing the website in communication with computer readable medium 30 and response 38 or notification of the response to the query is sent to reviewer's location 40. The reviewer can then access the responses or send the review information 42 back to the computer readable medium. Review information 44 can be sent to the original posting subscriber in location 26 so that review information of each response can be used to rank the responses and the subscriber posting the query has the benefit of peer review or responses to the query.

When a response receives a concurrence, the concurrence value (C) for that response is increased by one. When a response receives a dissent, the dissent value (D) for that response increases by one. The peer review value is calculated by dividing the number of concurrences by the sum of the concurrence value and dissent value. Therefore, the peer value (P) is calculated by C/(C+D). The responses can then be displayed with the highest peer value at the top.

In the preferred embodiment, the peer value can be calculated by dividing the concurrence value less the dissent value for the particular response by the sum of all concurrence values (C_{T})and the dissent values (D_{T})for all responses. This is expressed by the formula (C−D)/(C_{T}+D_{T}). Therefore, the peer value is a function of not only the sum of concurrences, but a calculation based upon the total number of concurrences and dissents.

Further, the peer value can be calculated by subtracting the dissent value for that question from the concurrence value and dividing that number by the number of concurrences and dissents for that response. This calculation is illustrated by the formula: (C−D)/(C+D).

In another embodiment, the peer value can be calculated by dividing the concurrence less the dissents for each response by the total number of concurrence values for all responses. This is represented by the formula (C−D)/(C_{T}). This calculation can be modified by taking the results of (C−D)/(C_{T}) and dividing it by the total number of concurrences and dissents. The formula for this is ((C−D)/(C_{T}))/(C_{T}+D_{T}).

In another embodiment, the peer value can be calculated by dividing the concurrence less the dissents for each response by the results of subtracting the total number of dissents from the total number of concurrences. This is illustrated by the formula (C−D)/(C_{T}−D_{T}).

In another embodiment, the peer value can be calculated by dividing the concurrence less the dissents for each response by the total number of dissents. This is illustrated by the formula (C−D)/D_{T}.

In another embodiment, the peer value can be calculated by dividing the concurrence plus the dissents for each response by the total number of dissents. This is illustrated by the formula (C+D)/D_{T}.

The responses can be sorted by peer value, inverse peer value, total responses, number of concurrences or number of dissents.

In one embodiment, an indicator can be added to the display to indicate whether the peer value is greater then 0.5, equal to 0.5 or less than 0.5. This provides a visual indication as to whether the response received more concurrences than dissents, more dissents then concurrences, or is neutral. In one embodiment, visual indicators can also be displayed when the peer value is above a predetermined value or when the peer value is below a predetermined value. For example, when the peer value is less then 0.25, a yellow indication can be displayed. When the peer value is less then 0.05, a red indication can be displayed.

By way of example, the following table is illustrative:

| Response | Concur | Dissent | Neutral | Total | Peer Value |
|---|---|---|---|---|---|
| C | 20 | 1 | 4 | 21 | 0.95 |
| B | 35 | 4 | 1 | 39 | 0.90 |
| A | 45 | 10 | 2 | 55 | 0.82 |
| D | 10 | 30 | 0 | 40 | 0.25 |
| E | 0 | 80 | 0 | 80 | 0.00 |

As can be seen, five responses (A-E) are provided to a query. The respective review information for each response is shown above. The peer review value is then calculated and the responses are displayed in order of the peer value with the highest valued response appearing first.

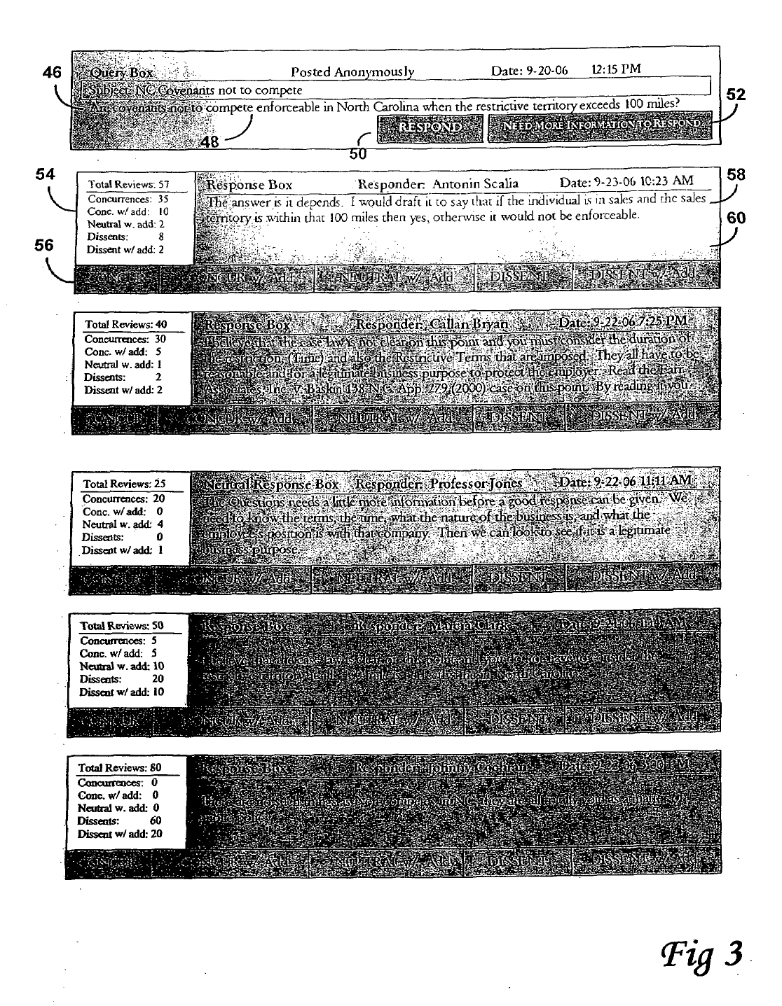

Referring now to FIG. 3, a query 46 is posted on the server. Once it is posted, a query box or notification of a posted query is transmitted to subscribers. The query box contains the query 48, a button to allow a response 50, and a button to request more information to respond at 53. Further, responses or notification of a response, if subscriber requests, are also transmitted to subscribers and response box can contain statistics concerning the total number of reviews at 54, the response at 58, and a color indicator as to whether there are more concurrences or more dissents by the subscribers who review the response 60 to show visually “equal ranking” of the response. The statistical data at 54 on the response box can show the subscribers by name or other identifier by placing curser over individual lines of statistical data and links to a secondary response, if any, or information about the subscriber. Review selections 56 are included with the response box to allow a response reviewer to concur (agree), concur with additional comments (agree with a secondary response), neutral with additional comments (not agreeing or disagreeing but opening a secondary response box with additional information, questions, perspectives for other subscribers who review or respond), to dissent (disagree), or to dissent with additional comments (disagree with a secondary response). In one embodiment, colored backgrounds in the response boxes can indicate the responses ranking by subscribers; a shade of green can be used to show a favorable response, grey can be used to show a neutral response, and red can be used to show a response that contains more dissents. Further, the response boxes are ranked in hierarchal order so that the responses that receive the more favorable reviews by the subscribers are higher on the list and the responses that receive the less favorable reviews by the subscribers are lower on the list (see FIG. 3). Thus, the response at the top of the list has received the most concurrence or has the highest peer value and this response is more probable than not to be accurate, correct or the best solution for the query posted. The other responses are listed according to rank based on peer value. In another embodiment, subscribers can be allowed to review or respond anonymously and the community will determine the weight given to anonymous versus named reviews or responses. In one embodiment, a concurrence or dissent from an anonymous review is afforded a value less than that of a registered reviewer.

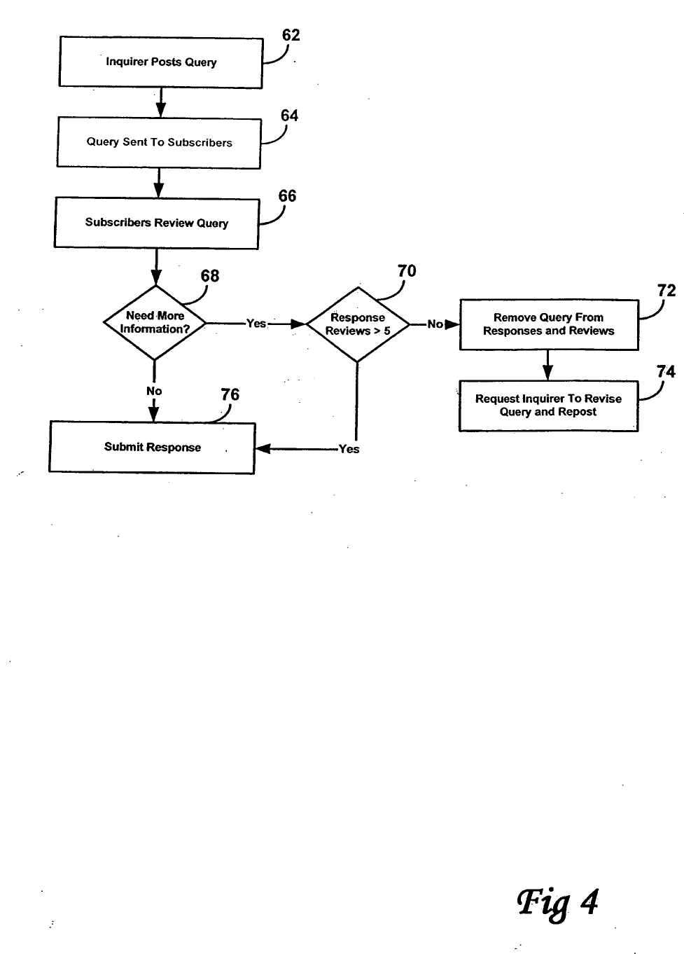

Referring now to FIG. 4, the inquirer posts a query at step 62. The query is sent to subscribers, or notification is sent to the subscribers in step 64. The subscribers can review the query in step 66. In one embodiment, the subscribers then determine if they need more information from inquirer to respond to the query and prevent a response by subsequent subscribers in step 68. If they do not need additional information from inquirer, subscribers then can submit a response in step 76. If more information is needed from the inquirer, a determination on whether there are more than five responses, reviews of responses or secondary responses to the query in step 70. If there is not more than five, the query is removed from the response and review process in step 72 and the inquirer is requested by e-mail to revise the query and repost it in step 74. If there are greater than five responses or reviews, then a response is entered at step 76. In one embodiment, the community can set the number of responses, reviews of responses or secondary responses at step 70, and allows the subscriber to request the information desired to the inquirer in the notification e-mail at step 74.

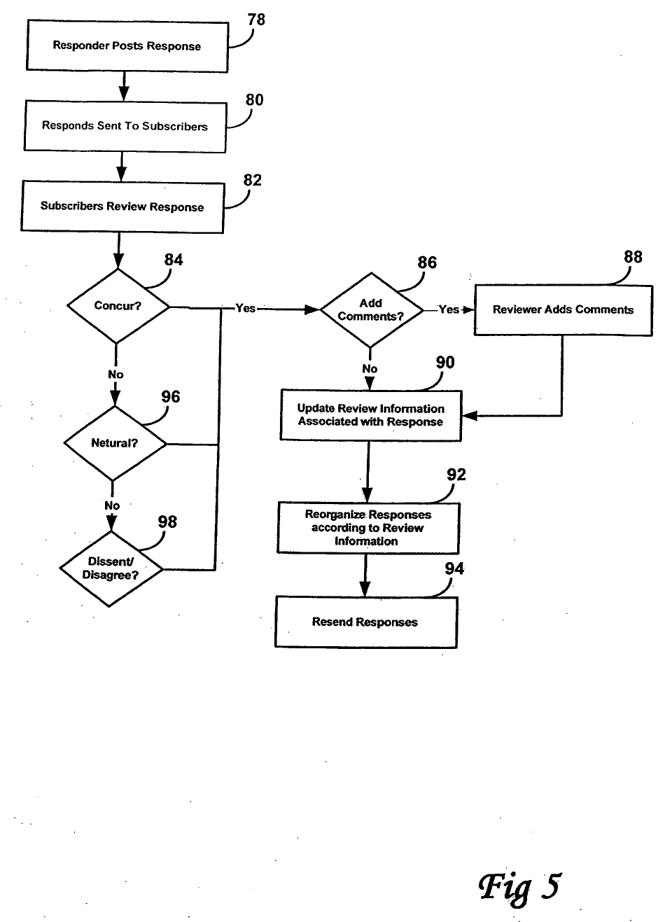

Referring now to FIG. 5, once the responder posts a response to a query at step 78, the response or notice of response is sent to subscribers in step 80. If the reviewer concurs with the response, then a query is made as to whether comments need to be added at step 86. If the reviewer wishes to add comments to the initial response, a secondary response box is opened and comments are added at step 88. The initial response is credited with the reviewer's concurrence, neutral or dissent and the secondary response is posted at step 78, along with the initial response italicized in the secondary response box. The review information associated with the response is updated at step 90 and the response is reorganized according to the review information in step 92. The reorganized responses or notification can be sent to the subscribers in step 94. In one embodiment, the reorganized responses are not sent to the subscribers, but rather maintained on the server for access by the subscriber without being notified of the updates and the review information. In another embodiment, the subscribers can choose how much activity a query gets before being notified. In step 84, if the reviewer does not concur, a query is made as to whether the responder believes there is a neutral addition or comments to the initial response. If the answer is yes, then the query for comments is made in step 86 and a secondary response box is opened and comments are added at step 88, and the process is repeated. If the reviewer does not have neutral comments, the query is made at step 98 whether there is a dissent or disagreement with the response, if yes, and then a query is made as to whether comments need to be added at step 86. If the reviewer wishes to add comments to the initial response, a secondary response box is opened and comments are added at step 88. The initial response is credited with the reviewer's concurrence, neutral or dissent and the secondary response is posted at step 78, along with the initial response italicized in the secondary response box and the process is repeated.

While a preferred embodiment of the invention has been described using specific terms, such description is for illustrative purposes only, and it is to be understood that changes and variations may be made without departing from the spirit or scope of the following claims.

What is claimed is:

1. A review system comprising:
a computer readable medium;
a set of member information embodied in said computer readable medium representing individuals that wish to participate in online discussions and having an electronic address associated with each member; and,
a set of computer readable instructions embodied in said computer readable medium for receiving initial discussion content generated by an originating member, generating a new discussion notification, transmitting said new discussion notification to said members, receiving a comment to said initial discussion content from a commenting member, transmitting said comment to each member, receiving review information from a reviewing member wherein said review is associated with said comment and wherein said review information include feedback information selected from the group of concur, concur and comment, neutral comment, dissent and dissent and comment, and transmitting said review information to at least one member.

2. The system of claim 1 including:
opt-in information embodied in said computer readable medium and associated with said member information representing whether a member wishes to participate in said discussion; and,
said computer readable instructions include instructions for retrieving said opt-in information from said computer readable medium, transmitting said new discussion notification only to members that have selected to opt-in to said discussion, transmitting said comment only to members that have selected to opt-in to said discussion, and transmitting said review information only to members that have selected to opt-in to said discussion.

3. The system of claim 1 wherein said computer readable instructions for transmitting said new discussion notification to said members includes instructions for transmitting a link to said discussion content to said member.

4. The system of claim 1 wherein said computer readable instructions include instructions for receiving a plurality of comments to said initial discussion content, receiving a plurality of review information, ordering said comments according to said review information, and transmitting said comment to at least one member with said comments ordered according to said review information.

5. The system of claim 4 wherein said computer readable instructions for ordering said comments according to said review information includes instructions for ordering said comments according to a formula selected from one of (C−D)/(C_{T}+D_{T}), (C−D)/(C+D), ((C−D)/(C_{T}))/(C_{T}+D_{T}), (C−D)/(C_{T-D}_{T}), (C−D)/D_{T} and (C+D)/D_{T}.

6. The system of claim 4 wherein said computer readable instructions include instructions for ordering said comments according to said review information includes instructions for awarding a first value to said comment representing said feedback information of said review information having a review of concur, awarding a second value to said comment representing said feedback information of said review information having a review of concur with comment, awarding a third value to said comment representing said feedback information of said review information having a review of neutral, awarding a fourth value to said comment representing said feedback information of said review information having a review of dissent with comment, awarding a fifth value to said comment representing said feedback information of said review information having a review of dissent, and ordering said comments according to the sum of said first, second, third, fourth and fifth values.

7. The system of claim 1 wherein:
monitoring information is embodied in said computer readable medium and associated with said member information representing whether a member wishes to monitor said discussion, said comments to said discussion, and said reviews to said comments; and,
said computer readable instructions include instructions for retrieving said monitoring information from said computer readable medium and transmitting said new discussion notification only to members that have selected to monitor new discussion content is posted, transmitting said comments only to members that have selected to monitor comments, and transmitting said reviews only to members that have selected to monitor reviews.

8 The system of claim 1 wherein:
said discussion information includes termination criteria representing when comments to said initial discussion content will cease being received; and,
said computer readable instructions include instructions preventing members from posting comments to said discussion content if said termination criteria has been met.

9. The system of claim 1 wherein said computer readable instructions include instructions for receiving a need more information request from a member representing that said member needs more information prior to commenting to said initial discussion content and transmitting said need more information request to said member who originated said discussion content.

10. The system of claim 9 wherein said computer readable instructions include instructions preventing members from posting comments when a need more information request is received.

11. The system of claim 1 wherein said members can stores said discussion content, comments and reviews on said computer readable medium for future retrieval.

12. The system of claim 1 wherein said computer readable instructions include instructions allowing members to transmit discussion content to members and non-members having electronic addresses.

13. A review system comprising:
a computer readable medium;
a set of member information representing members that wish to participate in an online discussion embodied in said computer readable medium;
a set of discussion content embodied on said computer readable medium representing discussion topics of interest wherein at least on discussion topic includes a plurality of comments associated with said discussion content; and,
a set of computer readable instructions embodied in said computer readable medium for receiving review information from a reviewing member wherein said review is associated with a comment and wherein said review information include feedback information selected from the group of concur, concur and comment, neutral comment, dissent and comment and dissent and transmitting said review information to at least one member.

14. The system of claim 13 including:
opt-in information embodied in said computer readable medium and associated with said member information representing whether a member wishes to participate in said discussion; and,
said computer readable instructions include instructions for retrieving said opt-in information from said computer readable medium and transmitting said review information only to members that have selected to opt-in to said discussion.

15. The system of claim 13 wherein said computer readable instructions include instructions for ordering said comments according to said review information, and transmitting said comment to at least one member with said comments ordered according to said review information.

16. The system of claim 15 wherein said computer readable instructions for ordering said comments according to said review information includes instructions for ordering said comments according to a formula selected from one of (C−D)/(C_{T}+D_{T}), (C−D)/(C+D), ((C−D)/(C_{T}))/(C_{T}+D_{T}), (C−D)/(C_{T}−D_{T}), (C−D)/D_{T} and (C+D)/D_{T}.

17. The system of claim 15 wherein said computer readable instructions include instructions for ordering said comments according to said review information includes instructions for awarding a first value to said comment representing said feedback information of said review information having a review of concur, awarding a second value to said comment representing said feedback information of said review information having a review of concur with comment, awarding a third value to said comment representing said feedback information of said review information having a review of neutral, awarding a fourth value to said comment representing said feedback information of said review information having a review of dissent with comment, awarding a fifth value to said comment representing said feedback information of said review information having a review of dissent, and ordering said comments according to the sum of said first, second, third, fourth and fifth values.

18. The system of claim 13 wherein:
monitoring information is embodied in said computer readable medium and associated with said member information representing whether a member wishes to monitor said reviews to said comments; and,
said computer readable instructions include instructions for retrieving said monitoring information from said computer readable medium and transmitting said reviews only to members that have selected to monitor reviews.

19 The system of claim 13 wherein:
said set of discussion content includes termination criteria representing when reviews to said comments will cease being received; and,
said computer readable instructions include instructions preventing members from posting reviews to said comments if said termination criteria has been met.

20. The system of claim 13 wherein said members can stores said discussion content, comments and reviews on said computer readable medium for future retrieval.

21. The system of claim 13 wherein said computer readable instructions include instructions allowing members to transmit discussion content, comments and reviews to members and non-members having electronic addresses.

22. A review system comprising:
a computer readable medium; and,
a set of computer readable instructions embodied in said computer readable medium for receiving discussion content from an originating user via a first terminal representing a discussion topic where the originating user wishes to receive comments concerning said discussion content, displaying said discussion content on a second terminal so that commenting users can provide comments directed to said discussion comment, receiving a comment from said commenting user, displaying said discussion comment and said review to said discussion comment on a third terminal so that a reviewing user can provide a review to said comment, and receiving a review to said comment from said reviewing user wherein said review include feedback information selected from the group of concur, concur and comment, neutral, dissent and comment, and dissent.

23. The system of claim 22 wherein said computer readable instructions include instructions for transmitting said comment to said originating user.

24. The system of claim 22 wherein said computer readable instructions include instructions for transmitting said review to said commenting user.

25. The system of claim 22 wherein said computer readable instructions include instructions for receiving a plurality of comments to said discussion content, receiving a plurality of reviews for at least one comment, and displaying said comments in an order according to said reviews.

26. The system of claim 25 wherein said computer readable instructions for displaying said comments in order includes instructions for ordering said comments according to a formula selected from one of (C−D)/(C_{T}+D_{T}), (C−D)/(C+D), ((C−D)/(C_{T}))/(C_{T}+D_{T}), (C−D)/(C_{T}−D_{T}), (C−D)/D_{T} and (C+D)/D_{T}.

27. The system of claim 25 wherein said computer readable instructions for displaying said comments in order include instructions for awarding a first value to said comment representing said feedback information of said review information having a review of concur, awarding a second value to said comment representing said feedback information of said review information having a review of concur with comment, awarding a third value to said comment representing said feedback information of said review information having a review of neutral, awarding a fourth value to said comment representing said feedback information of said review information having a review of dissent with comment, awarding a fifth value to said comment representing said feedback information of said review information having a review of dissent, and ordering said comments according to the sum of said first, second, third, fourth and fifth values.

28. The system of claim 22 wherein said computer readable instructions include instructions for receiving termination criteria representing when comments to said discussion content will cease being received and preventing members from posting comments to said discussion content if said termination criteria has been met.

29. The system of claim 22 wherein said computer readable instructions include instructions for receiving a need more information request from a commenting user representing that said commenting user needs more information prior to commenting on to said discussion content and transmitting said need more information request to said originating user.

30. The system of claim 29 wherein said computer readable instructions include instructions preventing users from posting comments when a need more information request is received.

31. The system of claim 22 wherein said users can stores said discussion content, comment and review on said computer readable medium for future retrieval.
